(19) United States
(12) Patent Application Publication
(10) Pub. No.: US 2023/0214932 A1
(43) Pub. Date: Jul. 6, 2023

(54) AUTOMATED DATA FILTRATION AND POPULATION FOR STREAMLINED ONLINE PROCESSING

(71) Applicant: Billd, LLC, Austin, TX (US)

(72) Inventor: Christopher Lee Doyle, Austin, TX (US)

(21) Appl. No.: 18/092,814

(22) Filed: Jan. 3, 2023

Related U.S. Application Data
(60) Provisional application No. 63/295,648, filed on Dec. 31, 2021.

(51) Int. Cl. G06Q 40/08; G06Q 50/16

(52) U.S. Cl. CPC G06Q 40/08; G06Q 50/16

(57) ABSTRACT

Systems and methods of automated population of data for streamlined online processing are provided. Information related to a contractor may be received over a communication network from a contractor database. Such data may be automatically filtered based on a set of one or more filtration rules, and a resulting filtered data set may sent to a designated device for processing. Different parties may be associated with different filter sets. A recommended match may be identified and sent to a device associated with each contractor. Each recommended match may correspond to such recommended insurance coverages or changes thereof, as well as a matched insurance or other service provider. The notification regarding the recommended may further include a link to automatically establish a connection to a system of a matched service provider and to automatically populate an online form with the contractor information.

### CROSS-REFERENCE TO RELATED APPLICATIONS

The present patent application claims the priority benefit of U.S. provisional patent application 63/295,648 filed Dec. 31, 2021, the disclosure of which is incorporated by reference herein.

### BACKGROUND OF THE INVENTION

### 1. Field of the Disclosure

The present disclosure generally pertains to automated data processing, and more particularly related to automated data filtration and population for streamlined online processing.

### 2. Description of the Related Art

Construction and similar projects may involve a variety of different types of parties each having associated with different sets of data, including contractors, sub-contractors, suppliers, property owners, lenders, etc. Such a project may generally entail the various parties providing information regarding one or more associated contracts, each of which may include information that needs to be verified, validated, and assessed. Moreover, each of the different parties involved may maintain different subsets of the data in different forms and formats, and as a result, project management has generally been a highly-specific manual process by which human managers manually search for, collect, and review different documents and data sets. Such manual processes may be time-consuming and require trained personnel to perform.

In most commercial construction situations, contractors, who specialize in a specific trade, work under a general contractor who in turn works for the property owner. Contractors purchase materials or other items from a supplier, who is paid by the contractor. A contractor may pay the supplier by borrowing money from a lender or a property owner. For example, a contractor may apply through a property owner or an individual representing the property owner or may submit an application electronically over the Internet. Credit offers are available from many different sources, such as traditional banks, insurance providers, private and commercial money lenders. Further, lending institutions, such as banks, assess credit offer risk using credit reports and/or credit scores. Credit reports are records sent from a credit reporting agency to prospective property owners, employers, and insurance providers that provide information about the credit standing of a consumer. Credit reporting agencies are companies that gather information about consumers and sell it to creditors and/or employers and/or insurance providers. A contractor may also make a payment agreement with a Supplier directly and pay according to a defined set of terms. For example, the supplier might require the contractor to pay within 30 days of receipts of the supplies.

Current processes performed by each party—for establishing credit offers, facilitate insurance providers to evaluate factors such as credit score, income, age of credit, outstanding debt, historical payment performances, and asset recovery value related to the contractor—often involve the same data, but are generally prepared and processed separately in accordance with primarily manual workflows. Such workflows may therefore be repetitive, inefficient, time-consuming, and therefore costly. For example, various documents and forms may include or request a credit score, which refers to a number generated by a statistical model that is used to objectively evaluate the creditworthiness of the contractor(s) (including contractor's income) relevant to making a credit decision. In particular, the income of the contractor is money that the contractor or a business receives in return for working, providing a product or service, or investing capital. Further, age of credit or length of credit history may be referring to how long any account has been open. In addition, the outstanding debt is defined as the total principal as well as interest amount of a debt that has yet to be paid, which is of core importance for any company which has used debt financing. The outstanding debt is important because it expresses a dollar amount to be paid before liability is closed. Further, historical payment performances refer to the pattern or the percentage of payments made in the past, related to the borrower. Furthermore, the asset recovery value is the projected value of an asset that can be recovered in the event of liquidation or winding down. The asset recovery value is calculated as the recovery rate times the expected recovery value of the asset.

The above-mentioned methods are quite useful but are suboptimal due to the narrow focus only on factors directly related to contractors, and not including information related to general contractors which may cause the insurance providers to face higher risk due to less information about the contractor they are insuring and underwriting. There are presently no available systems for automated coordination, population, or streamlining of such data across complex project documentation.

Therefore, there is a need for an improved system and method for automated data filtration and population for streamlined online processing.

### SUMMARY OF THE CLAIMED INVENTION

Embodiments of the present invention include systems and methods of automated data filtration and population for streamlined online processing are provided. Information related to one or more contractors may be received over a communication network from a contractor database. Such information may include both financial and business information of the contractor, and information on a general contractor or property owner to which the contractor is connected. Such data may be automatically filtered based on a set of one or more filtration rules, and a resulting filtered data set may sent to one or more designated recipient devices for processing. Different recipients may be associated with different filter sets. Online information sources may further be automatically monitored with respect to information relating to the contractor(s). One or more recommended matches may be identified and sent to a device associated with each contractor. Each recommended match may correspond to such recommended insurance coverages or changes thereof, as well as one or more matched insurance or other service provider. The notification regarding the recommended may further include a link to automatically establish a connection to a system of a matched insurance provider and to automatically populate.

### BRIEF DESCRIPTION OF THE DRAWINGS

FIG. 1 illustrates an exemplary network environment in which a system for automated data filtration and population for streamlined online processing.

FIGS. 2A and 2B illustrate exemplary contractor databases.

FIG. 3 illustrates an exemplary insurance database.

FIG. 4 illustrates an exemplary insurance company database.

FIG. 5 is a flowchart illustrating a method of automated data filtration for streamlined online processing.

FIG. 6 is a flowchart illustrating an associated method of automated data population for streamlined online processing.

### DETAILED DESCRIPTION

Embodiments of the present invention include systems and methods of automated population of data for streamlined online processing are provided. Information related to one or more contractors may be received over a communication network from a contractor database. Such information may include both financial and business information of the contractor, and information on a general contractor or property owner to which the contractor is connected. Such data may be automatically filtered based on a set of one or more filtration rules, and a resulting filtered data set may sent to one or more designated recipient devices for processing. Different recipients may be associated with different filter sets. Online information sources may further be automatically monitored with respect to information relating to the contractor(s). One or more recommended matches may be identified and sent to a device associated with each contractor. Each recommended match may correspond to such recommended insurance coverages or changes thereof, as well as one or more matched insurance or other service provider. The notification regarding the recommended may further include a link to automatically establish a connection to a system of a matched insurance provider and to automatically populate.

General Contractor: A general contractor in commercial building development is a person, party, or organization which provides resources or services such as labor, material for completing a project, on a contract basis. The contract may be defined for a pre-defined scope and a certain price. Further, the contractor may be catering to multiple clients at the same time and may have a financial history and business history based previous contracts.

The contractor is responsible for the overall management of the project. The contractor may make use of bids for acquiring the project in the first place. Further, the contractor is accountable to any profit from the contract work. The contractor forms an agreement with the Property Owner. The contractor may also contract with subcontractors that are necessary to complete the project.

Contractor: A Contractor sub-contractor in a commercial building development is a person, party, or an organization which is hired by a general contractor of the commercial building development to perform a specific task associated with the building development. The Contractor is liable to the general contractor and is hired when a specific task requires certain set of skills or specialization. An example is a flooring company (contractor) may be hired by the general contractor to install a gymnasium floor for a new high school. The contractor purchases material, coordinates logistics with general contractor, submits material detail logs to general contractor for approval, provides labor to install the floor, quality checks the installation and provides a warranty to the general contractor for the performed work.

The contractor may be responsible for completing a specific portion of the contract, based on particular set of skills of the contractor. For a single project, multiple contractors can be hired by the general contractor for different tasks. The contractor forms an agreement with the general contractor and not with the property owner. The contractor may be in contact with a network of general contractors.

Contractor profile: A contractor profile represents professional achievement, with roles and responsibilities, of a specific contractor during the execution of different projects undertaken by the contractor over a period of time. The contractor profile includes data and documents referring to various activities associated with the project(s) and also contains general information such as contacts, telephone numbers, email addresses, etc. and specific information related to the contractor.

The contractor profile is mostly open to public access and ensures transparency. Any normal person can view or check the contractor profile via the internet and can decide to select or reject the specific contractor, based on their requirements. The contractor profile can provide various activities associated with the project(s) such as information regarding corporate values of the company, mission, experience based on the project, steps for client satisfaction, Labor resources, safety information, quality assurance program, design capability, Project Management and controls, Miscellaneous Maintenance, etc. undertaken by the contractor over a period of time.

Contractor revenue: Contractor revenue is the revenue generated against a contract undertaken by the contractor. The contractor revenue is also known as transaction price, which is defined as consideration, the contractor receives, in exchange for their services after the completion of a project on a reporting date.

The contractor revenue is dependent on multiple factors such as initial amount of revenue agreed for the execution of a contract or variations in the contract work, claims and incentive payments. The contractor revenue may increase or decrease by uncertainties such as cost inflation, penalties arising from delay etc. The uncertainties depend on the outcome of the future events. For example, the total contractor revenue included of revenues from the sale of recyclable materials less recyclables revenue payments or the total contractor revenue may also include of revenue received by the contractor for the sale of franchised materials or their resulting by-products.

Contractor expenses: Contractor expenses are the expenses incurred by a contractor during the interval between the execution and completion of a project. The contractor business expenses incorporate costs incurred during the daily course of the project. They can be applied to small projects and large projects. The Income statement is determined by the contractor expenses which is revenue to arrive at a contractor's taxable total income and subtraction of business expenses. The contractor expenses are directly proportional to the cost inflation during the project completion time, and it may increase than what it was during the previous year(s).

The contractor expenses are related to the trade of the contractors. The contractor business expenses incorporate the company emergence, accountancy fees, business travel expenses and accommodation, postage and stationery for business, training which directly related to the business to upgrade their skills, business phone calls, and equipment or machine purchased for business purposes. The Internal Revenue Code (IRC) mentions the guideline regarding business expenses in its section 162. It includes all the expenses which are common in the business industry and necessary for business purposes. Several contactor expenses are fully tax deductible such as advertising and marketing expenses, a few legal fees, utility expenses, etc. while some are partially tax deductible.

Contractor capital equipment: The contractor capital equipment is the items a contractor acquires but does not consume during the normal course of business or execution of a project. The items include assets that are primarily used for construction purpose such as machines, large vehicles, tools, computers, etc. Capital Equipment Policy is considered prior to make a purchase.

The companies obtain capital items to handle the business and to earn returns from the assets. A Construction project has the right set of equipment to get the job done. Getting the perfect equipment for each work helps with efficiency, safety, and build quality. Some equipment has many uses, while others are specific to a task. The capital equipment is assets, the expenditure required to put the assets in place, and ancillary costs such as taxes, installation charges, duty cost, freight, and insurance cost. The fixed asset category is subdivided into Capital equipment that includes industrial machinery and tools, office tools, large vehicles for transportation, furniture, and others. All these items are appropriately chargeable to the capital account.

Credit offer for contractor material: A credit offer for contractor material is a credit offer taken by the contractor for procuring the construction materials. Such type of credit offer enables a contractor to pay for the project materials not from their own funds. Also, contractors get cash to pay to the material suppliers before they can get paid by their customers. Thus, the contractor gets ordered materials long before they actually start work on a project.

Contractors mostly depend upon construction material credit offers to cover material expenses and protect their cash flow position. There are many ways that contractors can fund their material purchases through such credit offers such as trade credit, bank credit offers, supplier financing, and credit cards. Contractors open trade credit accounts with their material suppliers and avails the flexibility to delay payments for a certain period of time. To apply for bank credit offers, the contractors are required to provide audited financial statements that shows their business stability and success. Many contractors also use credit cards to purchase materials for their projects and pay the credit card company back according to the terms of the agreement which depends upon their credit score.

Credit offer—credit offer covered by materials: The credit offer is a type of credit offer covered by materials in the form of a credit card or credit offer to the contractor. The credit offer structure is covered for the material that depends on the project's cash flow for repayment, with the project's assets, rights, and interests. The Credit offer is also defined as offers provided by a ledger, such as banks, to the contractor for the material purchase.

Lenders may determine the type of credit offers, such as a cash back credit card or low interest credit card, based on the requirement. All such offers are governed by various acts such as the Fair Credit Reporting Act (FCRA). Contractors are provided with flexible credit offers based on their requirements. The terms offered for such credit offers depend on whether the credit offer from the lender is preapproved or prequalified. Preapproval is when a lender pre-screens a contractor and independently determines whether they meet their requirements for credit. If they meet the requirements for credit, then the lender sends a preapproved offer. Prequalification is when the contractor agrees to provide their credit information to a lender. Prequalification does not require a firm offer of credit.

Credit offer interest rate: The Credit offer interest rate is the rate at which a credit offer borrower is charged on the principal amount borrowed from a bank or a lender. Thus, the credit offer interest amount depends on the percentage of the principal amount borrowed from the bank or the lender. The annual interest rate applied on the sanctioned amount is termed as annual percentage rate (APR). The rate of interest is the effective rate for the borrower for credit offer and rate of return to the lender.

Some mortgages utilize simple interest, however, other utilize compound interest, which is applied to the principal and to the accumulated interest of prior periods. The credit score of an applicant is a primary factor to decide the interest rate by lending institutions. Other factors which impact credit offer interest rates are nature of employment or business, age, income etc. The income of the borrower determines their capacity to repay the credit offer. A borrower with a higher income has a better financial bandwidth to repay the credit offer on time. Also, the risk level for such type of borrower is low and lenders may prefer such borrowers with low-risk profiles and hence they offer you a lower interest rate.

Credit offer term:

The amount of time a lender gives to a borrower to repay the sanctioned credit offer is called the Credit offer term. It defines the repayment time period and various factors associated with the credit offer such as rate of interest, penalty fees (in case of delayed payment) depending upon this time period.

In return for a specified amount of money, the borrower accepts to a certain repayment plan with a fixed or floating interest rate. The credit offer is repaid by the borrower in regular payments over a set period of time. The period of time can be decided by the borrower which can last between one year to as long as 30 years in some cases. The borrower repays the credit offer amount with monthly or quarterly repayment principal and interest amount. The credit offer needed collateral and a rigorous approval procedure to minimize the risk of default or failure to receive the payments. Term credit offers normally carry no penalties if they are paid off prior of scheme time period. The credit offer team can be subdivided into short term credit offer, long term credit offer, and intermediate term credit offers. Example of Credit offer term, The Guaranteed credit offer which is also known as Small Business Administration (SBA) credit offer provides long-term financing. Short-term credit offers and revolving credit lines are also accessible to help with a company's instant and cyclical working capital requirements.

Contractor portal: A contractor portal is a virtual platform, used by a contract company or a person, to manage instructions and information that abide by organizational rules or customer requirements. The portal enables a user to register themselves based on different roles such as an administrator or customer. The users may access and navigate the portal based upon the login privileges assigned to them during registration.

The contractor portal can be used by various entities such as construction contractor, employer's contractors (HR firms) or any other entity which either hires or get hired on contractual basis. Such portals help the contractor to keep records of all the data related to their contract and make it accessible to all the stakeholders of the contract. The portal also provides the current information about the sources of supply and services to contract personnel.

Cloud: A cloud is a remote data storage system that logically stores the data. The data is stored in different physical storage servers, which are managed and owned by different entities. The owners of the cloud infrastructure are paid for the services they provide. The cloud can be accessed either through a collocated cloud computing service or by a web service application programming interface (API) or by applications that use the API which can be a cloud desktop storage, a cloud storage gateway or Web-based content management system.

A cloud can be used to store personal as well as public data. There is a default limit on the data storage depending upon whether the storage is for personal use or public use. The cost for securing the data stored in the cloud is always high because of the data being stored is in a distributed manner. The data is replicated and moved very often for security purpose so that no one can physically breach the data.

Computing device: A computing device is a multitasking device that consists of different elements. Such devices are capable of communicating with each other either directly or through a network. The computing device is used to carry out different functions such as a sequence of arithmetic or logical operations without human interference. Electronics devices take the input from the user, process the inputs, and calculates the output from the input. The mathematical devices which perform the calculations on the streams of binary format and equipment are controlled by the Central processing unit which has different software to perform different functions.

A computing device such as a PC, laptop, smartphone, or tablet is used by every individual and organization. The use of computing devices is vast, and its functionality fits in all the organizational work. The computing devices run on different operating Systems (OS) that makes them dominant in the surrounding. Several computing devices and peripherals perform data transfer by using infrared signals such as the signals used by a TV remote control device. Several laptops are equipped with IR transmitters and receivers for data transfer. Computers are used as a control system in several industries such as industrial robots and computer-aided designs. The computing devices have different configurations, models, designs, shapes, textures, weights, temperatures. The computing device has Internet connectivity and also have different software to perform connectivity between different devices to share information.

Network interface module: A network interface module (NIM) is an intermediate block that can be either hardware or software within an environment of a device. The module receives an incoming signal, such as RF (Radio Frequency) signal or HD (High Definition) signal and converts the received signal into a format that is understood by the device. Interface modules associate electronic devices with electrical systems at the control level. The module efficiently optimizes and manages the virtual network deployment. These modules are simply integrated into present architecture and hardware.

Routers and Ethernet LAN (Local Area Network) Switch are an example of network interface modules and are used for distributing consolidated virtual network traffic to a number of computing devices. Network Interface module can run on the central server based on the LAN/WAN (Wide Area Network) flexibility and availability. It controls a subset of main databases related to the site it controls. Several Network interface modules can connect and transfer data between multiple devices and the central server utilizing Ethernet and Transmission Control Protocol 9TCP)/Internet Protocol (IP)protocols.

Processor: A processor is an integrated digital circuit, used for performing and processing instructions of a user. The processor is responsible for carrying out all the input and output duties of devices such as computers, laptops, smartphones, etc. The functionality of the input and output devices is dependent on the performance of the processor. The processor executes a variety of functions on the data stored in the memory (e.g., associated with modules described herein) or the data input by a user or data retrieved from outside digital sources.

A processor is made up of four units namely Arithmetic Logic Unit (ALU), floating-point unit (FPU) registers, and cash memories. All the units' function together and give desired output depending upon the type of input/instruction(s). There are many different types of processors such as central processing unit (CPU), Graphics processing Units (GPU), etc. The primary functions performed by the processor are fetched, decode, execute and write back. The basic elements of a processor are the arithmetic logic unit, floating point unit, Registers, and L1 and L2 cache memory. The common types of processors are multicore in which integrated chips (IC's) consists of two or more processors for strengthening its performance, reduction in power consumption, and processing of multiple tasks simultaneously.

Display: A display is an output device, used to present information such as visual data including graphics, text, and numerals. The display includes a screen or a projection surface on which the information is produced. It provides man machine interaction in electronic devices such as computers, laptops, smartphones, Television set, Head-mounted displays, Heads-up displays, Virtual reality headsets, Broadcast reference monitor, medical monitors, Video Walls, etc.

Displays are also called Video Display Terminals or monitors. The input data of display is generally a character map or Bitmaps. Displays are made up of cathode ray tubes (CRT), light-emitting diodes, and Liquid crystal display. A display device usually consists of a visual display, several circuitries, a cover casing and a power supply. Some of the features of the display are ultra-wide screen, touch screen, Indicator light, and Power saving. The performance measurement of the display device is based on the display size, color characteristics, Aspect ratio, Resolution, Gamut and Input speed characteristics such as refresh rate, response time, and input latency.

Contract or agreement: A contract or agreement is a formal legal binding agreement that governs the rights and duties between or among the organizations or parties. The elements of a contract are offer, acceptance, intention to create legal relations, consideration, and legality of both form and content. When one of the parties in the binding agreement fails to deliver according to the terms of the agreement, the contract is breached, and the parties involved can resolve the problem among themselves or in the court.

A contract is enforceable by law when it meets requirements of the agreement, consideration, contractual capacity and law object. Contract limits the ability to bargain because of some legal restrictions. Contracts are of two types; one is called bilateral and other one is called unilateral. A bilateral contract is an agreement in which each party of the contract makes a set of promises to each other whereas the unilateral contract is an agreement in which one party makes a promise, but the second party does not promise anything to the other party.

Good standing: A person or an organization in good standing compiles with all explicit obligations, while not being subject to any form of sanction, suspension or disciplinary censure. Good standing of a company or an organization is proved by a legal document which is as per the laws of a specific state. The document proves that the company does not owe taxes and permit it to do business in a particular jurisdiction officially. A good standing can be used as a condition to help prevent fraud applications for necessary information or documents.

A good standing certificate proves that the entity or organization has paid all the fees and filed all the important reports. It is a type of certificate which is required by the organization to transact business in states other than their home state of registration. The certificate also has an expiration date which comes when the registration is due to be renewed or is due for a periodic maintenance fee.

Notification for payment: Notification for payment is a process to automatically keep track of purchase or transaction in real time. Payment notification can be messages of payment success or payment failure or current status of a payment. An automatic backend function keeps track of the information related to order tracking, customer payment and accordingly provides notifications related to the acquired services or transactions.

For example, an e-commerce software may record the information about the payment transactions through a payment gateway. Further, when the invoice is requested from the payment gateway, a payment notification message is sent to the E-commerce software from the payment gateway for successful or incomplete transactions. Further, the information on the contract payment notification includes details of the subcontractor, details of the contract and a declaration that the contract is not a contract of employment. Before a payment is made to the subcontractor, revenue of the gross amount of the intended payment is always notified.

Notification that lien may be filed: The notification that lien may be filed is also referred as the notice to intent to lien (NOI). The NOI gives warning to the property owner or other party that a bond claim may be filed unless the payment of the overdue amounts is made within a certain period of time. The notice of the intent to lien could be a replacement for a demand letter.

In state, federal and other public works projects, there is no requirement for NOI. It is often useful to send the Notice of Intent to encourage the parties so that they can make payment to avoid facing lien claim. A notice of intent to lien can be a replacement for demand letter and have the extra benefit of being relevant to parties other than the debtor. The notice of intent to lien document notifies the key project stakeholders about a payment problem, they may not foresee, and it also gives other stakeholders an opportunity to resolve the problem before a more adversarial lien claim is filed.

Notification of a property lien: Notification of a property lien is a legal claim on the assets where a creditor may seize the property and give notification to the debtor. The holder or the creditor gains access to the property if the debts are not paid. Since lien is a public record and is generally filed with a state agency.

A notification is attached to an individual property in case of any default by the debtor. In such a situation, the creditor can file a case against the debtor and receive approval for the property lien through government or state agencies. The property lien includes repossession of real estate property or equipment. It is the final step taken by a creditor against the debtor for collecting the unpaid debt.

List of building materials: List of building materials are the list of raw materials used during the construction of a building. Such list of materials is also known as construction material list. Cement, steel, sand, concrete, ready-mix concrete, binding wires, aggregates, bricks, blocks, etc. are few examples of building/construction materials. Building material have different properties such as weight, strength, durability, and cost which makes these materials suitable for various construction activities.

The building materials are selected precisely ensuring the protection and long life of the building. The materials and products are used by construction project managers or contractors for completing undertaken construction projects. Building materials are naturally occurring materials or may be manufactured products i.e., some are more synthetic, and some are fewer synthetic materials.

Lien History: A lien history is a history of legal rights against assets that are used as collateral to satisfy a debt. The lien history is established by a creditor or a legal judgement. It forms security interest that is granted over an item of property to secure the payment of a debt. Depending on the history behind the lien, the liens are referred as part of the process of purchase and may not be considered as a deal breaker.

Liens are of two types i.e., Personal liens or corporate liens. The difference between both the liens is that the corporate lien can become a type of investment whereas the personal lien cannot be considered as a part of investment. Further, liens can be consensual or non-consensual. Consensual liens between the creditor and the debtor are imposed by a contract whereas the Non-consensual liens are imposed by statute or by the law.

Underwriting process: Underwriting is a method through which an individual or institution takes financial risk, such as taking a credit offer in lieu of premium, insurance, or investments for a fee. Underwriting helps to place fair rates for borrowing in credit offers, establish appropriate premiums, and develop a market for securities by accurately pricing the investment risk.

The underwriting is a key function in financial world. An underwriter is an individual that sells the minimum number of securities of a company for commission. There are three types of underwriting i.e., credit offers, insurance and securities. A human underwriter is required for mortgage credit offer underwriting. The policyholder is the main focus in insurance underwriting. Securities underwriting assess risk and the appropriate price of securities such as IPO.

Project credit offer: A Project credit offer is a credit offer structure that depends on the project's cash flow for repayment and takes into account the project assets, rights, and interests. The project Credit offer is also defined as offers provided by a ledger, such as banks, to the contractor based on the project. Project credit offer is used to fund long term projects. They are usually non-recourse credit offers, which are protected by the project assets and repayment of the project is done by the complete cash flow of the project.

The offer includes the build, operation, and transfer (BOT) of the projects. Project credit offer provides off-balance-sheet financing of the project. The project risk is shifted to lenders in exchange for which the lenders obtain a higher margin for lending. Project financing offer is more complicated and alternative financing methods to attract borrowers for its project by offering special credit offers based on its project. These offers can change with respect to time by the financial institutions as per their credit policies.

Account credit offer: Account credit offer is defined as offers provided by a financial institution, such as banks, against a customer account. The account credit offers are sent to a user for rejection or acceptance by any suitable means such as a text message and/or via telephonic call.

These offers are customer and bank oriented for e.g., different banks provide different account credit offer to different customers depending on the transaction activities of the customers. The account credit offer depends on lenders to determine the type of credit offers, such as a cashback credit card or low-interest credit card, based on the account activity and requirement of the user. All such offers are governed by various acts such as the Fair Credit Reporting Act (FCRA). These offers are subject to change with respect to time on the basis of the transactions done by the customer against their account. These offers are defined as per the financial institutions and on its policies towards customer accounts.

Account credit: The account credits are an accounting activity in which money is credited to the account. All accounts that contain a credit balance may increase in amount when credit is added to them and reduced when a debit is added. The category of accounts to which this rule covers are liabilities, revenues, and equity. The credit may also be in the form of rewards.

For example, the rewards or cashback received by a user of GPay, Paytm, Paypal or Phonepay is a type of account credit because cashback is reflected in the customer's account. The cashback can be used as a normal currency for purchasing any kind of goods and services. The account credit can also be in form of contract agreement between the borrower and the ledger in which the borrower receives credit in the form of money from the ledger and repays at a later day with interest. The individual or company that provides credit is termed as the creditor. Credit is provided in exchange for a product or service given by the creditor to the account holder.

Account credit limit: The account credit limit is defined as an upper limit of credit associated with an account as extended by a creditor. The account holder, or customer, is free to withdraw any amount up to and including credit limit from the concerned account. The credit limit, linked to a customer, is based on customer's credit score, and may also impact their ability to get the credits in the future.

A customer applies for a credit in form of either a credit card and/or credit offer. The lender, which may be any financial institution, evaluates risks associated with the customer based on multiple factors such as spending habits and credit score. Based on these factors, the lender set an upper limit on the credit that the customer may utilize without any adverse effect. If the borrower spends more than the credit limit, then the borrower is fined and is required to pay the penalty in addition to their regular payments.

Real estate owner: A real estate owner is defined as a legal entity whose ownership of any real estate or property is recognized by the law of the land. A legal entity can be either individuals and/or organizations. A real estate owner has the ultimate control and right to use the property as long as the law permits. A real estate owner can be categorized in different types i.e., Individual Ownership or solo ownership, Joint or Co-ownership, and property ownership by nomination.

Any constructor or a potential buyer contacts the real state owner with a contract or lease proposal to accrue the real state property. It is up to the owner to accept or reject the proposal. Further, it is the responsibility of real estate owner to pay taxes on all the real estate they own. A real estate owner always has the ultimate responsibility for the maintenance and repair of the property. A real estate owner can transfer the property without any limitations. One can become owner of real estate by acquiring legally from previous owner, either in exchange for money, or as gift or donation.

Payment credit offer schedule: The payment credit offer schedule is defined as the schedule according to which a credit offer should be repaid by the borrower. A credit offer is repaid in multiple instalments, each paid at a fixed interval of time. The schedule of fixed time intervals on which the instalments are paid is called as payment credit offer schedule.

Generally, the instalments are paid monthly and are commonly known as EMI. However, based on agreement of between lender and borrower, the instalments can also be paid quarterly, half yearly or annually. Instalments paid monthly are called EMI or equated monthly instalments. Instalments can be paid with fixed or variable rate of interest amount. Further it depends on the schedule of instalments. The payment credit offer schedule is important to the borrower to understand the credit offer repayment by breaking down the balance into equal monthly EMIs and also help borrower to calculate the total interest payable on the credit offer. The repayment schedule of the credit offer amount is the full list of that borrower is required to pay toward interest and principal over the period of the credit offer. The payment credit offer schedule is calculated based upon type of interest that is fixed rate of interest and variable rate of interest. During fixed rate of interest payment schedule remains fixed while during variable interest rate amount of payment of credit offer changes which also impact repayment schedule of the credit offer.

Credit limit: The credit limit is defined as a maximum amount of credit that can be used by a customer extended to them by a financial institution such as bank. The credit limit for a specific customer is based on customer's credit score and may also impact their ability to get credits in the future. Through the good credit score, it may affect the ability to get financing things like a car or start a business. The credit limit can also depend on the customer income.

For example, based on the customer credit score, one user may have one credit limit while the other user may have a different credit limit. The credit limit can be adjusted by the credit card issuer, if the customers are using the card wisely, for example, if the customer consistently made payments on time, the bank may increase the credit limit on customer current card because customers are considered less risky of a borrower to credit offer more money.

Insurance companies that insure against building material credit offers: The insurance companies that insure against building material credit offers are the companies which offer an insurance policy for the credit offers taken by the contractors to complete undertaken project. Sometimes, to procure building materials for construction of the building, the builder may need a credit offer. An insurance policy for building materials covers potential losses of builder during the construction phase of the building.

The building material credit offer helps contractors get money/finances to pay for their materials using cash received from bank. The insurance company that ensures building material credit offer check the signed document paper of contractor or builder and the documents include the budgets assigned to each portion of the project, building materials to be use and plans approved by the municipality. Further, if any chance the building materials gets damaged by fire, lightning, explosion, earthquake, and storm damage the risk Insurance Cover all.

Lien: Lien is defined as a legal right to keep possession of the property or real estate belonging to someone else until they have repaid all the debts. The lien is created by a creditor or legal entity and is mostly used to recover debt. When a borrower does not pay his mortgage or neglects to pay income or property taxes, a lien may be placed against his property as a way for the lender or the Internal Revenue Service to try and recoup what is owed to them.

The lien guarantees an underlying obligation such as repayment of credit offer. In case of failure of payment of the credit offer, the creditor or legal entity may seize the asset that is the subject of the credit offer. The lien may arise by the agreement of the parties, by the general usage of trade and by particular usage of trade. A lien can only be released by the organization or person who created it. However, some actions can take may release the lien including like, paying off the lien, settling the lien, correcting the lien, disputing the lien.

Liens—state laws: Liens state laws refer to different laws or guidelines set by different states concerning lien. Depending on the state, timelines for lien may change and therefore location of property should be kept in mind when initiating lien process. Different state liens laws have different timelines. In some states the lien of a properly docketed judgment affects all the debtor's property in every county where notice of the judgment is filed.

Where the contractor wants to work in a particular jurisdiction, they need to take measures of all the requirements by the Liens—state laws. The contractor should be aware of all the liens laws in that particular jurisdiction. A notification of a particular contractor working on a site should also be provided by the contractor to the government. The timelines of state lines laws can affect when you need to let the owner know you're working on a project.

Liens—federal laws: Liens federal laws are laws and guidelines regarding lien defined by the federal government. The federal law always controls federal lien property cases. A federal lien is the government's legal claim against your property when you neglect or fail to pay a tax debt. The government points out that a matter of federal law as to whether a lien created by a state statute is sufficiently specific. A federal tax lien records subsequent to an attachment lien, but prior to the date, the attaching creditor obtained judgment.

The federal law requires certified copy of the abstract of judgement and automatically creates lien on property or land in the state within district where court is situated. The federal court created judgement lien lasts for 20 years. Also, most of the states follows the 20 year 20-year rule but not some may not. The uniform Federal lien registration act provides for the registration of federal lien by procedures consistent with normal recording of mortgages in local area property records with the normal filing of security interest of personal property.

Specific actions to preserve their lien rights module: Lien is defined as a legal right to keep possession of the property or real estate belonging to someone else until they have repaid all the debts. The action to preserve the lien is to register the lien in the land registry office with the cost of land which the owner is claiming to be owed. Lien rights just by virtue of working on or contributing materials to a construction project, the right to lien may expire without the correct steps to preserve it.

Few steps such as sending notice, filing liens within a given time frame are to be fulfilled in order to preserve lien rights. Generally, direct contractors, subcontractors, material suppliers, equipment lessors, design professionals (architects and engineers), and laborer all have lien rights. A lien is a legal claim on the property title, which is very difficult to get rid of without paying the debt right. The lien rights help reduce financial risk for contractors, subs, and suppliers, all of whom are required to put up significant sums of their own money in advance.

Public or private rights module: The public right module deal with the social problems in the broad conditions and it includes constitutional law, administrative law, criminal law, and criminal procedure law. Rights that deal with public rights are permanently applicable to the state. It depends on the structure of the government. The private right module deals with situation influencing private individuals and corporations. Private rights depend on the substantive and legislative regulation governing relationship in-between individuals.

Private rights can be found in between organizations and employment. For example, the rules of behavior established by an employer. Subdivision of private rights are contract rights, law of torts, Property rights, Labor rights, Commercial rights, Corporations rights, Competition rights. Public rights are circumstances involving public bodies. Normally, public bodies and government officials get their authority to construct decisions and to take embodiment in the form of legislation.

Sending preliminary notice module: The sending of preliminary notice module is defined as sending a notice by a legal entity at the start of their work on a construction project on the real estate. The preliminary notice is required in order to protect right to file a mechanics lien or a bond claim in case the contractor or equivalent party is unpaid. A preliminary notice is a routine letter notifying the property owner of work on the project. Preliminary notices are an opportunity for contractors to introduce themselves to property owners and describe the services or supplies they plan to provide, encouraging transparency in their working relationship with the owner.

The preliminary notice may also be known as NTO (notice to owner), notice of furnishing, prelim, prelien etc. It provides information regarding the company, the work, or materials that the company is providing to the project, and the amount you anticipate being paid for the contributions. Subcontractors who provided professional services, materials, or equipment are required to send preliminary notice to the property owner 60 days from first delivering materials.

Sub-tier parties to send one notice module: The sub-tier parties to send one notice module is defined as sending, by the sub-tier parties like sub-contractors and suppliers, a notice to the main contractors and/or owner regarding their work and contribution and in order to file mechanics lien on construction projects.

The sub-tier parties should send notice for each project in order to get paid timely and move on another project. By sending the preliminary notices helps the sub-tier parties. Further, it brings the attention of the owner. However, Owners have the knowledge of particular companies working on their property. So, they can collect what they owned. Sub-tier parties send notice module make the time management better.

Notice of intent lien (NOI) module: The notice of intent lien is a notice defining consequences of non-payment. Using this, owner, main contractor and/or any other party is warned that mechanics lien or bond claim cannot be filed until/unless payment is made in a given time period. The notice of intent works as a demand letter. The Notice of Intent is the equivalent of a demand letter in a civil case and is generally considered the second step in the procedure for obtaining a lien, just before the formal filing of a lien claim with the court.

The notice of lien becomes ineffective as of the date all charges are paid in full. The notice of intent to lien tool is a kind of pressure release valve for the construction industry, which is popular for payment abuses, delays in work, and challenges regarding working capital. Notice of Intent lien documents typically produce better and faster results with contractors seeing payments an average of 20 days later.

Deadline module: Deadline module is defined as the module that has information about the completion time of every activity involved in a construction project. The owner of each project activity can plan their sub-activities as per the deadline mentioned in this module. Lien may not attach to property and is not enforced unless you have filed a lien within 90 days of deadline module.

The deadline module helps all the parties involved in a project keep track of timeline and anticipate any upcoming delays. Every state has their own specific notice deadlines module and form requirements. Even states that use the same name for preliminary notices vary greatly in their application. Each state has their own statutes that govern the rules and deadlines module for sending notice to protect payment.

Credit offer Appraisal: Credit offer appraisal is the specific credit offer application or proposal to assess the repayment capability of the credit offer applicant. A lender manages a credit appraisal chiefly to construct rules that to increase the probability that the lender gets back its money. Appraisal of credit offers requires a dynamic approach involving, inter alia, a projection of future trends of output, sales, and estimates of costs, returns and flow of funds. There are four broad aspects of credit offer appraisal, namely, technical feasibility, economic feasibility, managerial competence and financial or commercial feasibility.

The credit offer appraisal process checks financial elements, management, market, and other financial details of the credit offer applicant. All the banks and non-banking financial corporations (NBFCs) make use of a credit appraisal policy prior to approving any credit offer application. Each lender may have its own process for performing credit appraisal procedures to assess the credit worthiness of a particular credit offer applicant. The credit appraisal is performed to avoid the possibility of default on credit offers.

Credit offer equity: Credit offer equity is defined as consolidating high-interest debt at a lower interest rate. With equity funding, money is raised by selling a portion of ownership in the company. Equity credit offer amounts depend on the difference between a current market value and the mortgage due balance. An equity credit offer is the credit offer that is available to you against the equity on a property. A type of consumer debt, home equity credit offer is also known as an equity credit offer, a second mortgage or a home-equity instalment credit offer.

Equity is the difference between the present cost of property and the mortgage owed by the owner. An equity credit offer works similar to a home credit offer, both cases the home serves as collateral. However, for a home credit offer, the eligible credit offer amount is up to 90% of the market value of the house. The fastest way to build equity is to come up with a large down payment, the larger the down payment, the more equity immediately have in home.

Promotional annual percentage rate (APR): Promotional annual percentage rate is the APR of a credit card offered under promotion. Credit card companies charge interest on outstanding balance at the end of billing cycle. Rate of this interest is when annualized is known as APR. A very low APR, when offered as a promotional scheme, is called Promotional APR. The annual percentage rate or the interest rates are normally set high as a short tenure restricts lenders from making adequate profits.

The ledger decides the timing of the promotional rates. A zero percentage of promotional APR may cover to a card's purchase APR or balance transfer APR or both. It mainly dependent on the offer provided by the ledger. For example, if the ledger offers in the card a zero percent promotional APR for both qualifying purchases and balance transfers, the card holder won't have to pay any interest on qualifying purchases or balance transfers during the offer time period.

Contractor credit score: Contractor Credit score is defined as a credit score assigned to a contractor by credit bureaus. This is a measure of contractor's payment practices. Contractor Credit score indicates whether the contractor has a history of paying their bills on time, or if they are slow payers. Further, this score is also used when a contractor applies for a credit offer or line of credit.

The construction credit offers for business or a contractor line of credit depends on a multiple of elements that need to need to be contemplate, including lender requirements, types of credit offers, and contractor credit score. The lenders use the contractor credit score of an individual contractor to identify whether credit offer should be given to a contractor or not and if yes, then what amount can be given as a credit offer to the contractor.

Short term credit offers: A short-term credit offer is a type of Credit offer which is obtained for a short period of time. A business generally takes a short-term credit offer in order to tide over cash crunch in present with a future payment in sight. A short-term credit offer is a type of credit offer that is obtained to support a temporary personal or business capital need. Short term credit offers provide quick cash when your cash flow is lacking, have shorter repayment periods than traditional credit offers.

A prominent example of a short-term credit offer is the products/services purchased with the help of credit cards on EMI. Short term credit offers generally carry a higher rate of interest. Examples of short-term credit offers includes, Overdraft, credit card, Payday credit offers, money market, refund anticipation credit offer, bridge credit offer. Many borrowers prefer short-term credit offers from a direct lender that eliminates any intermediaries such as credit brokers.

Long term credit offers: A long-term credit offer is a type of credit offer which is obtained for a long period of time. This period can be up to 30 years. It is mostly used in a financial industries or organizations with long term goals. For such credit offers the sanction is based on stable and regular income of applicant, future prospect and/or any collateral to be submitted. Long term credit offers are popularly taken from banks and other financial institutions.

Home credit offer, Student/education credit offer, car credit offer etc. are examples of long-term credit offers as the repayment period is more than 3 years. Because of the longer tenure, the interest rates are lower, and many terms & conditions tend to be relaxed as compared to short term or quick credit offers these types of credit offers like education credit offers, car credit offers, home credit offers and certain kind of personal credit offers fall into this category. Benefits of taking a long-term credit offer are lower interest rate, maintain liquidity, flexibility, tax benefits, online application.

Line of credit: A line of credit is a facility provided by a financial institute. Instead of providing the full amount to customer at once, the full amount is stored in an account by the lender. The customer can withdraw any sum of amount, up to and including credit limit, if and when needed. The interest rate is paid only on the amount withdrawn. With a line of credit, a person may borrow as much or as little of the available credit as needed, and only pays interest and fees on that amount.

A credit card holder has a limit of credit available to them. It is not necessary for a card holder to withdraw all their credit once. Thus, a card holder has the provision of creating a line of credit according to their need. Another common line of credit is a home equity line of credit, it secured credit lines backed by the value of the borrower's home, and generally carry low interest rates. Lines of credit are also extended to business owners.

Cash advance: A cash advance is defined as a type of short-term credit offer. Like all short-term credit offers, this also comes with high rate of interest but has advantage of quick approvals or quick funds. In cash advance an amount of money that someone borrows and on which they start to pay interest as soon as they receive it. Credit card cash advances usually come with high fees. A cash advance doesn't directly affect credit score, and credit history won't indicate the borrowed one.

As an example, cash withdrawn from an ATM using a credit card is a form of cash advance. For example, most credit cards let borrow a set amount of cash as an advance that can be pay back with interest, but generally, we can only borrow up to card's cash advance limit and not full credit limit. When take a cash advance, it gets added to credit card balance and accrues interest until its repaid just like purchases and balance transfers do.

Factoring credit offer: The factoring credit offer is a method used by the organizations to raise capital. In a scenario when an organization is in need of capital, but invoices raised for its customers are still being processed, the organization may take a factoring credit offer from a lender using invoices as collateral. In such a scenario, the organization can raise capital up to 90% of invoices value. Financial institute receives payments made by the customers, deducts its fee and then releases rest to the organization.

A factoring credit offer is also known as factoring receivables and is an option for businesses that allow customers up to 3 months for payments. For example, if anyone want to expand business and need money in order to secure a bid for construction, then it can use factoring to get that money. Factoring companies do not take a large percentage of the invoice, a percentage upfront when they purchase the invoice, the rest of the money may come after they have collected, minus the fee they take.

Bankruptcy: Bankruptcy is a legal situation when an entity is unable to repay its outstanding debt. In such a case wherein, a debtor can't repay off its debt, files for bankruptcy in the court of law which may declare the debtor as bankrupt or insolvent. The court then appoints agents who then take the control of the assets of the debtors and apportions it in ratio of the debt owed by creditors on a pro-rata basis. The debtor is then declared as debt free.

For example, when a contractor or a builder borrower some amount from the lender or the bank as its working capital and is supposed to repay the amount to the bank in certain period of time. If the contractor is unable to pay the credit offer in its specific time, then the assets are all sold for the recovery of amount. But if the amount to be recovered by selling all the asserts is not fulfilled then the person is termed as bankrupt.

Collateral: A borrower's assets are referred as collateral when the borrower uses the assets as a security deposit to take out a credit offer. The assets are deposited so that if the borrower defaults on the credit offer, the lender can sell/auction the asset after seizing it and recover a part or full value of the credit offer. Collateral is any property or asset that is given by a borrower to a lender in order to secure a credit offer. Collateral acts as a guarantee that the lender may receive back the amount lent even if the borrower does not repay the credit offer as agreed.

A collateral can be any type of assets such as piece of land or invoices of payments or the business or etc. For example, if a person wants to take out a credit offer from the bank, he may use his house property as collateral. If he fails to repay the credit offer, the collateral may be seized by the bank, based on the two parties' agreement, if the borrower has finished paying back his credit offer, then the collateral is returned to his possession.

Personal guarantee: When a promoter/executive/director of a business makes personal legal promise that if the business fails to repay the credit in part or full, the individual may take the onus to repay the balance of the credit himself/herself; it is termed as personal guarantee. It acts as an extra security for the creditor that safeguards its interest in the credit transaction.

Generally, when the amount sanctioned by the lender is big then the lender may prefer to have both collateral as well as personal guarantee for its security. A personal guarantee can be anyone related to the borrower. It is not necessary to add a person in blood relation to the guaranteed list. Although it is necessary to get approval from the guarantee.

Business credit score: The business credit score refers to a number given by the credit rating agencies which implies that whether a company is fit/creditworthy to service a credit offer or not or if they are fit become a business partner/consumer. This score is obtained by analyzing the credit repayment history of the company and their relations with their suppliers and lenders. Multiple parameters such as liens, taxation history, legal proceedings, bankruptcies, longevity, business size etc. are accounted for before this score is given.

When a company or business wants to apply for a credit offer to fulfil its purpose, the Major criteria for getting the credit offer approved may be the business credit score. For credit offer approval, the revenue, profits, assets, and the collateral value of the purpose are required. The major credit scoring firms are Equifax, Experian, and Dun and Bradstreet.

Personal credit score: The personal credit score refers to a number (mostly between 300-850) given by the credit rating agencies (such as CIBIL, Equifax etc.) which implies that whether a person is fit/ creditworthy to service a credit offer. Higher is the credit core of a person, better are the chances of the person to obtain credit offer from lender. This scored is obtained by analyzing the credit repayment history of the person and their credit repayment behavior. The lenders use the credit score of individuals to identify whether credit offer should be given to a person or not and if yes, what amount can be given as a credit offer to the borrower.

When an individual applies for a credit offer to fulfil their purposes, the criteria which help them to get credit offer approval are the personal credit scores, assets, and income of an individual. It also helps the borrower to get the credit offer at the least rate of interest. For example, in personal good credit score, the person gets many benefits like cheaper to borrow money, best rates of cars, and homeowner insurance, and good rewards.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. “About” as used herein when referring to a measurable value such as an amount, a temporal duration, and the like, is meant to encompass variations of ±20%, ±10%, ±5%, ±1%, and ±0.1% from the specified value, as such variations are appropriate.

In one embodiment, a method for providing contractor information to adjust coverage, the method including the steps of receiving information related to one or more contractors from contractor database, wherein the information related to the one or more contractors includes both financial and business information of the contractor, and information on a general contractor or property owner to which the contractor is connected; performing filtration of the received information of the one or more contractors, sending the filtered information to an insurance module; monitoring for information from the insurance module; receiving information from the insurance module, wherein the information include insurance required to one of the one or more contractors and matched insurance provider to adjust the coverage; and establishing a connection between one of the one or more contractors and the matched insurance provider. For example, for contractor AB Flooring, with CIN—717, credit score—740, years in business—5 years, annual revenue—$3 million, and types of project—building construction, payment performance—credit offer L1 with a total amount of $4 million and fully paid amount of $4 million on time, average project score—7, criminal history—no, civil judgments—no., outstanding debt—No, lien history-no, and required amount of credit offer $90,000.

In one embodiment, the filtered information represents the current data of the contractor's financial and project data. For example, for contractor AB Flooring, the current data include the amount of credit offer $90,000, annual revenue $3 million, payment performance—credit offer L1 with a total amount of $4 million and fully paid amount of $4 million on time.

In one embodiment, the information received from the insurance module address includes need for insurance to the one or more contractors and the detail of the insurance provider. In one embodiment, the need for insurance to the one or more contractors is determined by calculating the current amount of credit offer and percentage of credit offer to the revenue of the one or more contractors. For example, for contractor AB Flooring, the amount of credit offer is $90,000, which is 3% of the annual revenue, therefore no insurance is needed as the percentage of credit offer is less than the value of predefined minimum percentage i.e. is 5%. In another case, for contractor AB Flooring, if the amount of credit offer is $600,000, which is 20% of the annual revenue, then insurance is optional as the percentage of credit offer is between the value of predefined minimum percentage i.e. is 5% and predefined minimum percentage i.e. 50%. In yet another case, for contractor AB Flooring, if the amount of credit offer is $18,00,000, which is 60% of the annual revenue, therefore insurance is required as the percentage of credit offer is greater than the value of predefined minimum percentage i.e. 50%.

In another embodiment, the need for insurance to the one or more contractors. is determined by calculating current credit offer history of the one or more contractors and determine the risk of the one or more contractors. For example, contractor AB Flooring has paid the credit offer on time, therefore no insurance is needed to him. In another case Alex has paid the credit offer fully but delayed the payment by two months, in that case the insurance to Alex is optional. In yet another case Alex has not paid the credit offer, in that case the insurance to Alex is required.

In yet another embodiment, the need for insurance to the one or more contractors. is determined by calculating a change in request for credit offer payment by the one or more contractors. In one case the contractor AB Flooring has paid the credit offer on time, therefore no insurance is needed to him. In another case the contractor AB Flooring has paid the credit offer fully but delayed the payment by two months, in that case the insurance to Alex is optional. In yet another case, the contractor AB Flooring has not paid the credit offer, in that case the insurance to Alex is required. Further, based on the received information the contractor AB Flooring get connected to system associated with the Bank of America over a communication network. Such connection may be initiated based on activation of a link associated with the identified system. Information regarding such link (and other connection data) may be stored in one or more databases in memory and/or retrieved from one or more remote databases, as well as presented for activation via IO GUI 112.

Referring now in detail to the drawings, in which like reference numerals indicate like parts or elements throughout the several views, in various embodiments, presented herein is a system and method for receiving contractor information and making the information available to insurance providers. Embodiments of the present disclosure may be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

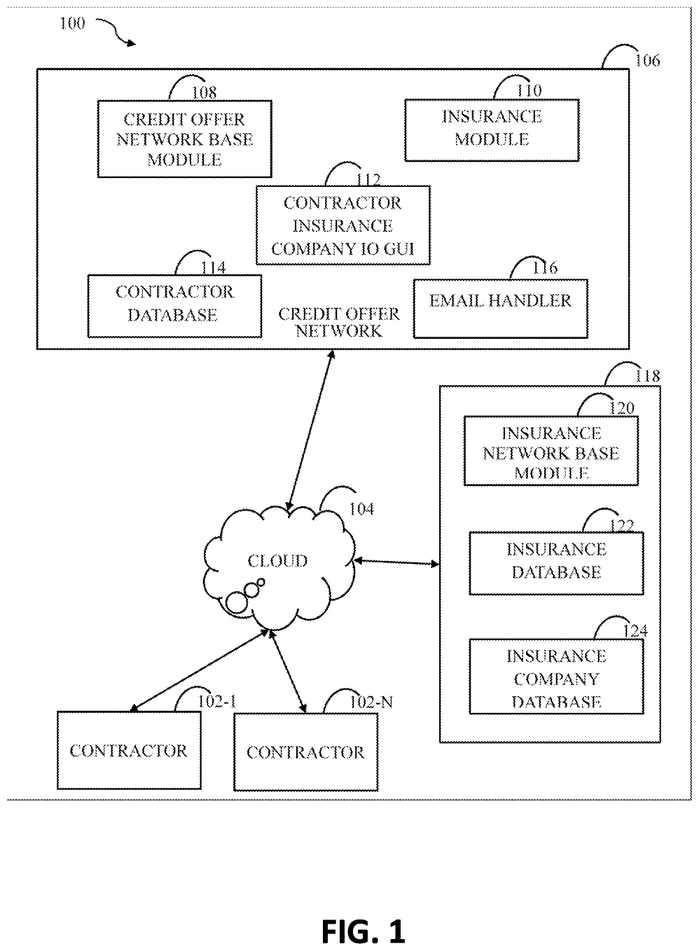

FIG. 1 illustrates an exemplary network environment 100 in which a system for automated data filtration and population for streamlined online processing. The network environment 100 may include one or more contractor devices 102-1-N, a cloud 104, and a data network server 106. It can be noted that the one or more contractor devices 102-1-N may be communicatively coupled to the data network server 106 via the cloud 104. Hereinafter, the one or more contractor devices 102-1-N may be referred to as contractors. It can be noted that the term contractor or sub-contractor may be used interchangeably to refer to device associated with one or more users, clients, or other entities.

In one embodiment, the contractor devices 102 may be associated with construction contractors. It can be noted that the construction contractors may correspond to, but are not limited to, building construction contractors, road construction contractors, bridge construction contractors, and tunnel construction contractors. The contractor devices 102 may include a computing device, desktop, laptop, smartphone, table, computer, smart speaker, smartphones, other wireless digital/cellular devices, or I/O devices to communicate with the data network server 106 via the cloud 104. The computing device may include an input device and an output device. The input device may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output device may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs through combining some of the inputs and outputs. Some devices allow for facial recognition which may be utilized as an input for different purposes including authentication and other commands. devices allow for voice recognition and inputs, including, e.g., Microsoft KINECT, SIRI for iPhone by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), or force-based sensing technologies. Some multi-touch devices may allow two or more contact points with the surface, allowing advanced functionality including, e.g., pinch, spread, rotate, scroll, or other gestures.

Further, the cloud 104 may be inclusive of any communication network implemented for connecting the various devices in the network environment 100. In one embodiment, the cloud 104 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The cloud 104 may allow ubiquitous access to shared pools of configurable resources and higher-level services that can be rapidly provisioned with minimal management effort, often over the internet and relies on sharing of resources to achieve coherence and economies of scale, like a public utility, while third-party clouds enable organizations to focus on their core businesses instead of expending resources on computer infrastructure and maintenance. The cloud 104 may also use standard architecture and protocols as understood by those skilled in the art, such as, for example, a packet switched network for transporting information and packets in accordance with a standard transmission control protocol/Internet protocol (“TCP/IP”). Additionally, the network environment 100 may utilize any conventional operating platform or combination of platforms (Windows, Mac OS, Unix, Linux, Android, etc.) and may utilize any conventional networking and communications software as would be understood by those skilled in the art. Additionally, the cloud 104 may be communicatively coupled to the contractor devices 102 through computing devices and the data network server 106, to allow the contractor devices 102 to connect to the data network server 106.

Further, the cloud 104 may be used to share information related to the contractor devices 102. Thus, to protect data of the contractor device 102, such as sensitive user financial and personal identification data, government data related to the construction or site plans, other confidential data, and to comply with state and federal laws pertaining to protection of financial and personal identification data, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file by using a Secure Socket Layer (SSL) with dual key encryption. Additionally, the network environment 100 may limit data manipulation or information access. For example, a system administrator may allow for administration of the system at one or more levels, such as at an individual reviewer, a review team manager, a quality control review manager, or a system manager. Further, the system administrator may also implement access or use restrictions for users at any level. Such restrictions may include, for example, the assignment of user names and passwords required for use of the system run a check for or to implement an adjustment, backend administrative access, associated mobile device apps, or the selection of one or more data types that the subservient user is allowed to view or manipulate.

In one embodiment, the data network server 106 may be used to implement the methods described herein that provide information of the contractor device 102 or sub-contractor to an insurance provider to adjust coverage. Further, the data network server 106 may include executable software corresponding to a credit offer network base module 108, an insurance module 110, a contractor insurance company input output (I/O) graphical user interface (GUI) 112, a contractor database 114, and an email handler 116.

The credit offer network base module 108 may be utilized to connect the contractor devices 102 to the insurance provider or an insurance providing company. In one embodiment, the credit offer network base module 108 may include a filter module executable to filter current data of the contractor in accordance with one or more sets of filter parameters. Each party may be associated with different sets of filters. As such, filtering related to a transaction involving multiple parties may include combining different sets of filters, which may further include prioritizing different filters and resolving filter conflicts. In exemplary implementations, learning models may be developed to improve filtering by identifying filter sets and related actions (e.g., prioritized filter parameters, conflict resolution) associated with successful transactions. Such models may be based on historical data regarding identified successful transactions and parameters thereof. Such historical data may be continually updated to include new and updated data regarding new or updated transactions.

Further, the insurance module 110 may be executable to determine one or more recommendations (e.g., in accordance with different applicable requirements, best practices, policies) for insurance and search for a matching insurance company. In one embodiment, the insurance module 110 may determine the need for insurance by calculating the required amount of credit offer and determining percentage of the required credit offer to revenue associated with the contractor device 102 request. In another embodiment, the insurance module 110 may determine the need for insurance by obtaining and analyzing credit history of the contractor devices 102, determining risk levels, and generating recommendations. In yet another embodiment, the insurance module 110 may determine the need for insurance by calculating a change in request for credit offer payment performed by the contractor devices 102 and determining the risk associated with the contractor device 102 requests.

Further, the contractor insurance company I/O GUI 112 may be a user device GUI or guided user interface(s) that may either accept inputs from user devices, facilitate output to the users, and/or may perform both the actions of input and output. Contractor insurance company I/O GUI 112 may further present the results of backend processing by other modules 108/110 of data network server 106 (as well as contractor devices 102 and devices of the matching service provider(s)), including automatically filtered data sets and populated online forms, fields, dashboards, overlays, and other ways of presenting custom filtered data sets or analyses thereof.

In one case, a user can interact with the interface(s) using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface.

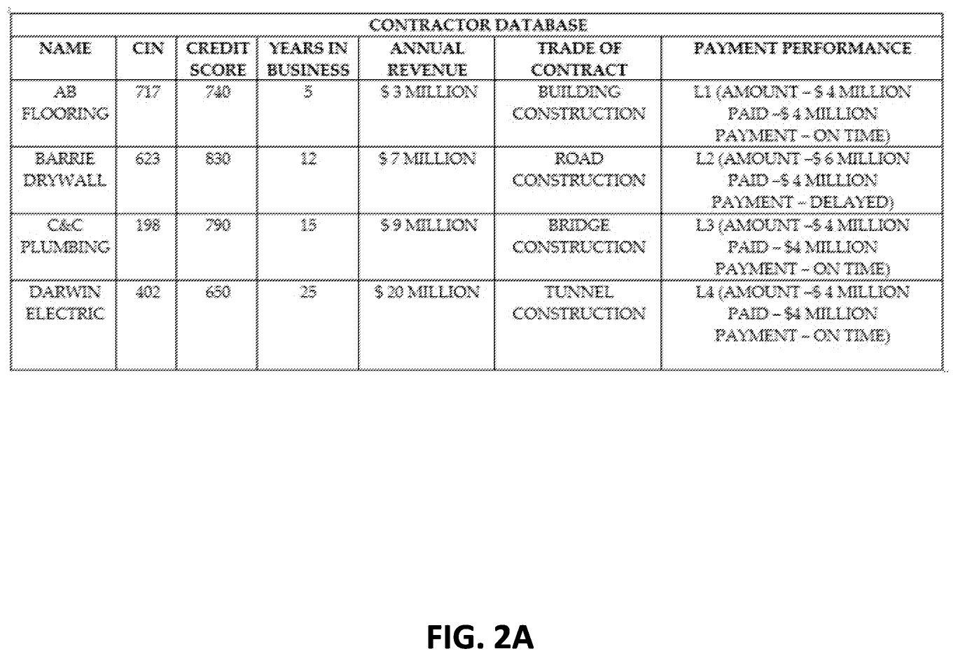

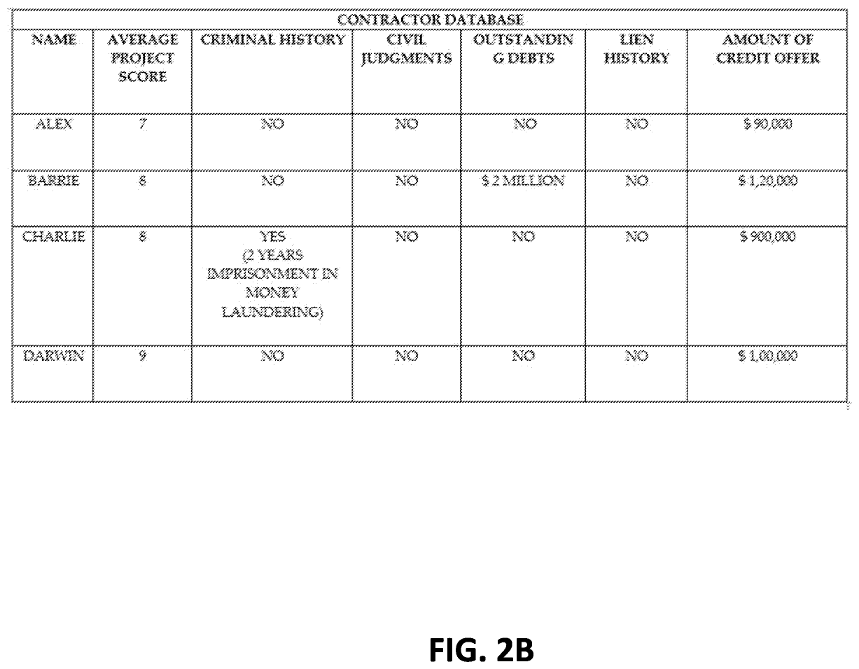

Further, the contractor database 114 may be used to store data related to the contractor devices 102. The contractor database 114 may include structured data of all the contractors and sub-contractors in terms of their profiles, their contract for credit for materials, lien data in the contracts of when liens can be levied. In one embodiment, the data may include at least but not limited to credit score, years in business, annual revenue, type of project, payment performance, average project score, criminal history, civil judgments, outstanding debts, and lien history of the contractor devices 102. In one embodiment, the data may be provided to the insurance provider to aid with underwriting. In another embodiment, the data may be provided to insurance, bonding, real-estate lender, and other property owners. Further, the contractor database 114 may be configured to store a systematic collection of data used for electronic storage and manipulation of data. In one embodiment, the contractor database 114 may be of various types such as but not limited to centralized database, cloud database, and network database. It can be noted that the information stored in the contractor database 114 may reflect a robust picture of the contractor's business and financial soundness. There are no limitations to the number, type or connectivity of the contractor database 114 utilized by the network environment 100. It can be noted that an exemplary contractor database 114 may be shown in FIG. 2A and FIG. 2B.

FIGS. 2A and 2B illustrate exemplary contractor databases. As illustrated, the contractor database 114 may include details related to contractor AB Flooring, including the name—Alex, CIN—717, Credit score—740, years in business—5 years, annual revenue—$3 million, and types of project—building construction, payment performance—credit offer L1 with a total amount of $4 million and fully paid amount of $4 million on time, average project score—7, criminal history—no, civil judgments—no., outstanding debt—No, lien history—no, and required amount of credit offer $90,000. Further, the contractor database 114 includes details related to contractor Barrie Drywall, including the name—Barrie Drywall, CIN—623, Credit score—830, years in business—12 years, annual revenue—$7 million, and types of project—road construction, payment performance—credit offer L2 with a total amount of $6 million and paid amount of $4 million delayed, average project score—8, criminal history—no, civil judgments—no., outstanding debt—$2 million, lien history-none, and required amount of credit offer $1,20,000. Further, the contractor database 114 includes details related to contractor C&C Plumbing, CIN—198, Credit score—790, years in business—15 years, annual revenue—$9 million, and types of project—bridge construction, payment performance—credit offer L3 with a total amount of $4 million and paid amount of $4 million on time, average project score—8, criminal history—yes (2 years of imprisonment in money laundering case, civil judgments—no., outstanding debt—no, lien history-no, and required amount of credit offer $9,00,000. Further, the contractor database 114 includes details related to contractor Darwin Electric, CIN—402, Credit score—650, years in business—25 years, annual revenue—$20 million, and types of project—bridge construction, payment performance—credit offer L4 with a total amount of $4 million and paid amount of $4 million on time, average project score—9, criminal history—no, civil judgments—no., outstanding debt—no, lien history-no, and required amount of credit offer $1,00,000.

Further, the email handler 116 may be used to enable the interaction between the network environment 100 and the contractor devices 102. It can be noted that the email handler 116 may store a set of email scripts to send out email and related data to the contractor devices 102 based upon the event generated. In one embodiment, the email handler 116 may send an email to the contractor devices 102, data about a lien, a code for the email received from the credit offer network base module 108, and credit offer adjustment, in case the lien gets detected for a first time. In an exemplary embodiment, when the lien is detected for a contractor AB Flooring project, the credit offer network base module 108 sends data about the lien as well as instruction to the email handler 116 to send “email 3”. On receiving the instruction, the email handler 116 populates an email of one of the contractor devices 102, data about the lien, a credit limit adjustment of “X” in case the credit risk has increased, and the stock information. It should be noted that the network environment 100 aggregates all the information and create and send email through the email handler 116 automatically. Further, the email handler 116 is also configured to look at the emails received from the contractor devices 102 and classify them using machine learning. The classification of the emails may be performed based on the response of the contractor devices 102 such as contractor agrees or contractor would like to talk to the insurance provider. After performing the classification, the email handler 116 may send the response to the credit offer network base module 108.

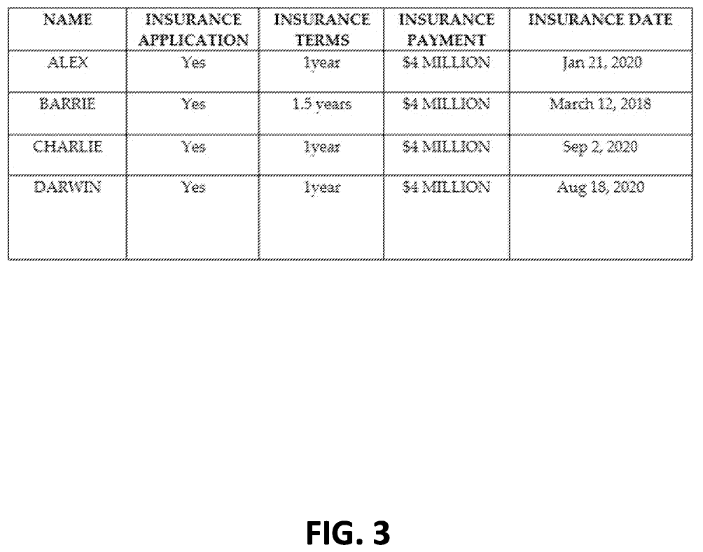

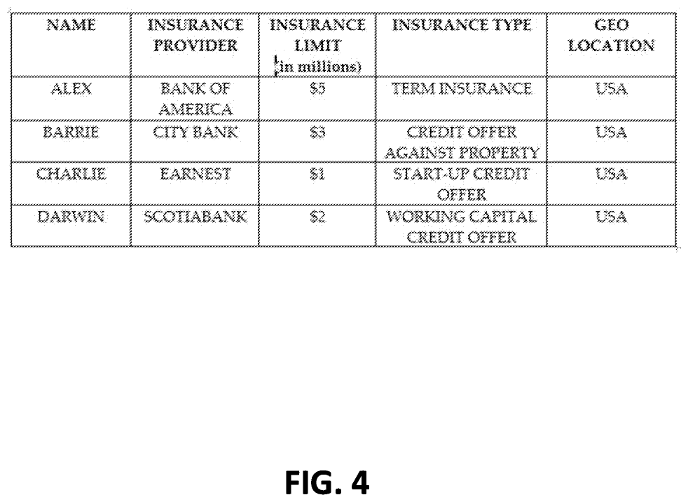

Further, the cloud 104 may facilitate the data network server 106 to connect to an insurance network 118. The insurance network 118 may include an insurance network base module 120, an insurance database 122, and an insurance company database 124. In one embodiment, upon receiving a request from the insurance module 110, the insurance network base module 120 may be configured to search for the insurance company, for the purpose of underwriting. Further, based on the request received from the insurance module 110, the insurance network base module 120 may search the insurance database 122, and the insurance company database 124. The insurance database 122 may include all the information about the insurance of the contractor devices 102. In an exemplary embodiment, the insurance database 122 may include the information such as insurance application, insurance terms, insurance payments, and insurance dates. Further, the insurance company database 124 may include one or more data related to the insurance providers. The one or more data may include name, address, and type of the insurance provider. In one embodiment, the insurance network base module 120 may search the insurance company in the insurance company database 124. It can be noted that an exemplary insurance database 122 may be shown in FIG. 3 and insurance company database 124 may be shown in FIG. 4.

FIG. 3 illustrates an exemplary insurance database. The insurance database 122 includes details related to contractor AB Flooring, including name—Alex, insurance application—yes, insurance terms—1 year, insurance payment—$4 million, insurance date—Jan. 21, 2020. Further, the insurance database 122 includes details related to contractor Barrie Drywall, including the name—Barrie Drywall, insurance application—yes, insurance terms—1.5 year, insurance payment—$4 million, insurance date—Mar. 12, 2018. Further, the insurance database 122 includes details related to contractor C&C Plumbing, insurance application—yes, insurance terms—1 year, insurance payment—$4 million, insurance date—Sep. 2, 2020. Further, the insurance database 122 includes details related to contractor Darwin Electric, insurance application—yes, insurance terms—1 year, insurance payment—$4 million, insurance date—Aug. 18, 2020.

FIG. 4 illustrates an exemplary insurance company database. The insurance company database 124 includes details related to Insurance company, including name—Bank of America, insurance Limit—%5 million, insurance type—term insurance, geo location—USA. Further, the insurance company database 124 includes details related to Insurance company, including name—city bank, insurance Limit—$3 million, insurance type—credit offer against property, geo location—USA. Further, the insurance company database 124 includes details related to Insurance company, including name—Earnest 4.2, insurance Limit—$1 million, insurance type—start—up credit offer, geo location—USA. Further, the insurance company database 124 includes details related to Insurance company, including name—Darwin Electric, insurance Limit—$2 million, insurance type—working capital credit offer, geo location—USA.

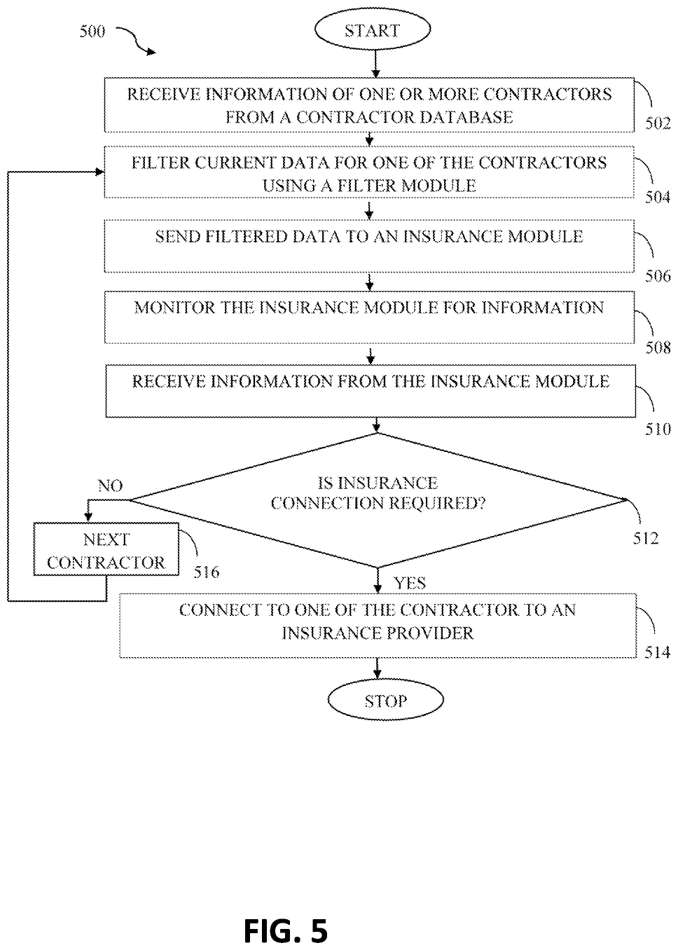

FIG. 5 is a flowchart illustrating a method 500 of automated data filtration for streamlined online processing. It should also be noted that in some alternative implementations, the functions noted in the blocks may occur out of the order noted in the drawings. For example, two blocks shown in succession in FIG. 5 may be executed substantially concurrently or the blocks may sometimes be executed in the reverse order, depending upon the functionality involved. In addition, the process descriptions or blocks in flowcharts should be understood as representing decisions made by a hardware structure such as a state machine. The method 500 starts at step 502 and proceeds to step 516.

At step 502, the credit offer network base module 108 may receive information of the contractor devices 102 from the contractor database 114. In one embodiment, the information of the contractor devices 102 may be retrieved from the contractor database 114 and processed in accordance with automated workflows for one or more transactions with one or more service providers. As discussed herein, the information of the contractor devices 102 may include, but is not limited to, name of the contractor, contractor identification (ID) number (CIN), credit score, years in business, annual revenue, trade of contractor, payment performance of the contractor, average project score of the contractor, criminal history, civil judgements, outstanding debts, lien history, and required amount of credit offer. For example, the credit offer network base module 108 receives the information of the contractor AB Flooring from the contractor database 114 as CIN—717, credit score—740, years in business—5 years, annual revenue—$3 million, and types of project—building construction, payment performance—credit offer L1 with a total amount of $4 million and fully paid amount of $4 million on time, average project score—7, criminal history—no, civil judgments—no., outstanding debt—No, lien history—no, and required amount of credit offer $90,000. In another embodiment, the information of the contractor devices 102 may include contractor contact information and contract information. In one embodiment, the contract information includes the size of job engagement with the contractor. For example, for Alex, the size of job engagement is constructing a building within a year. Different types of contractors may have different types of information available, and while described herein specifically in relation to construction general contractors, different types of contractor information may be relevant for transactions involving other types of contractors.

At step 504, the credit offer network base module 108 may filter the current data for one of the contractor devices 102 by executing a filter module based on the received information of the contractor devices 102. Thus, the current data may be filtered by applying the filter module by a set of filter parameters associated with the contractor devices 102. Such filter parameters may be based on default presumptions associated with the contractor role and/or may further be based on specific information associated with the contractor (as maintained in a stored profile or provided by contractor devices 102). Thus, the filter parameters may be different for each role (e.g., contractor, sub-contractor, creditor, and different types thereof), as well as each individual entity.

In one embodiment, the current data may be filtered for a first contractor at the time of initialization of the network environment 100. The current data may include required amount of credit offer, annual revenue, and payment performance. For example, the filter module in the credit offer network base module 108 is running for the first time, so it filters the current data for first contractor AB Flooring. The filtered current data includes amount of credit offer $90,000, annual revenue of $3 million, payment performance—credit offer L1 with a total amount of $4 million and fully paid amount of $4 million on time. In another embodiment, the current data may be filtered for the next contractor if the filter module in the credit offer network base module 108 is already functioning. In an exemplary embodiment, the current data is filtered for the contractor Barrie Drywall. The filtered current data includes amount of credit offer $90,000, annual revenue of $7 million, payment performance—credit offer L2 with a total amount of $6 million and delayed payment of $4 million. Each contractor device 102 may provide data differently, including differing levels of detail and presentation, thereby requiring different types of analyses and filtering processes in order to obtain a dataset suitable for processing by credit offer network base module 108.

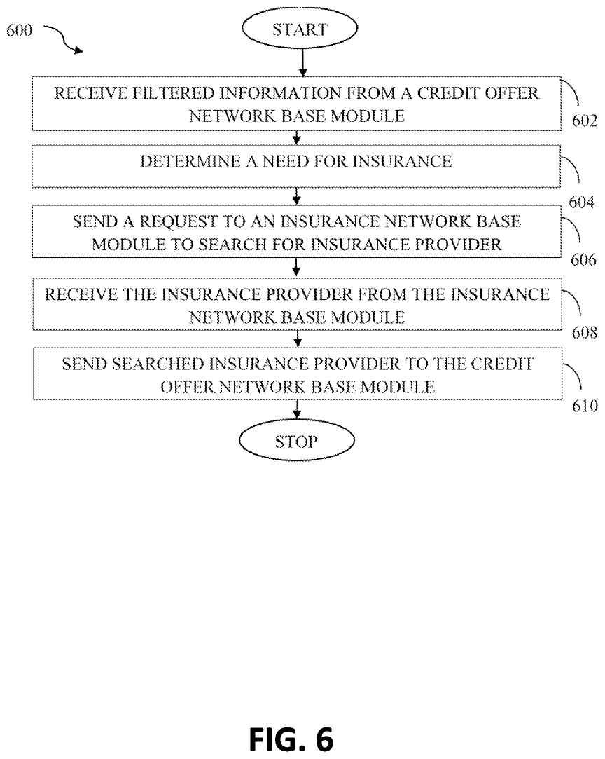

Further, the filtered current data may be sent to the insurance module 110 at step 506. In some implementations, various online sources associated with the filtered current data (e.g., different remote databases, rules database regarding legal, financial, or other policy requirements) may be monitored and used to update the filtered current set of data upon request or automatically in real-time. In an exemplary embodiment, the filtered data for the first contractor AB Flooring is sent to the insurance module 110, which includes the amount of credit offer $90,000, annual revenue of $3 million, payment performance—credit offer L1 with a total amount of $4 million and fully paid amount of $4 million on time. The insurance module 110 may use the filtered current data to calculate the need for insurance and search for insurance provider. It can be noted that the insurance module 110 is explained in FIG. 6.

FIG. 6 is a flowchart illustrating an associated method 600 of automated data population for streamlined online processing. It should also be noted that in some alternative implementations, the functions noted in the blocks may occur out of the order noted in the drawings. For example, two blocks are shown in succession in FIG. 6 may be executed substantially concurrently or the blocks may sometimes be executed in the reverse order, depending upon the functionality involved. In addition, the process descriptions or blocks in flowcharts should be understood as representing decisions made by a hardware structure such as a state machine. The method 600 starts at step 602 and proceeds to step 610.

The insurance module 110 may receive information of the contractor devices 102 at step 602. In one embodiment, the information of the contractor devices 102 may be received from the credit offer network base module 108. For example, the insurance module 110 receives information for the first contractor AB Flooring as amount of credit offer $90,000, annual revenue $3 Million, payment performance—credit offer L1 with a total amount of $4 million and fully paid amount of $4 million on time. In another embodiment, information of the contractor devices 102 may be received from the contractor database 114.

Upon receiving the information of the one of the contractor devices 102, the insurance module 110 may determine the need for insurance (or change thereof) for the received one of the contractor devices 102 at step 604. For example, the need for insurance may correspond to an adjustment to existing coverage by an insurance provider. In one embodiment, the insurance module 110 may calculate the current amount of credit offer and determine the percentage of credit offer to the revenue of the received one of the contractor devices 102. In one case, if the credit offer is less than the predefined minimum percentage of the annual revenue of the received one of the one or more contractor devices 102, then no insurance may be provided. For example, for the first contractor AB Flooring, the amount of credit offer is $90,000, which is 3% of the annual revenue, therefore no insurance is needed as the percentage of the credit offer is less than the value of predefined minimum percentage i.e. is 5%. In another case, if the credit offer is between predefined minimum percentage of the annual revenue of the contractor devices 102 and predefined maximum percentage of the annual revenue of the contractor devices 102, then insurance may be optional. For example, for the first contractor AB Flooring, if the amount of credit offer is $600,000, which is 20% of the annual revenue, then insurance is optional as the percentage of the credit offer is between the value of predefined minimum percentage i.e. is 5%, and predefined minimum percentage i.e. 50%. In yet another case, if the credit offer is greater than the predefined maximum percentage of the annual revenue of the contractors, then insurance may be required. For example, for the first contractor AB Flooring, if the amount of credit offer is $18,00,000, which is 60% of the annual revenue, therefore insurance is required as the percentage of credit offer is greater than the value of predefined minimum percentage i.e. 50%.

Such analyses may be based on analytical rules associated with the insurance provider (or other service provider), which may either be provided by the individual service provider or identified using historical data regarding successful and unsuccessful transactions with one or more service providers. In some implementations, insurance module 110 may use online forms associated with the service provider to perform the analyses. Such usage may include automated population of one or more fields of associated online form(s) to obtain a result. In some implementations, updated online forms (e.g., new fields, requirements) may further trigger updates to automated workflows for obtaining the required information from contractor devices 102 (in step 502 of FIG. 5).

In another embodiment, the insurance module 110 may obtain and analyze the current credit offer history of the received one of the contractor devices 102 and determine a risk level for the received one of the contractor devices 102. In one case, if the credit offer is always paid on time, then no insurance may be required. For example, the first contractor AB Flooring has paid the credit offer of amount $4 million on time, therefore no insurance is needed for him. In another case, if the credit offer is paid in full but not timely then insurance may be optional. For example, the first contractor AB Flooring has paid the credit offer of amount $4 million fully but delayed the payment by two months. In that case, the insurance may be determined to be optional. In yet another case if the credit offer is ended in default, then insurance may be required. For example, the first contractor AB Flooring has not paid the credit offer of amount $4 million taken earlier and defaulted; in that case, the insurance is required for Alex. Such analytical results associated with one or more insurance providers may be generated and presented via IO GUI 112.

In yet another embodiment, the insurance module 110 may calculate a change in credit offer payment requested by the received one of the contractor devices 102 and determine the need of insurance for him. In one case, if the request for credit offer payment is changed from quarterly payment to monthly payment, then no insurance may be required. For example, contractor AB Flooring has changed the plan of credit offer payment from quarterly to monthly, therefore no insurance is needed for him. In another case, if the request for credit offer payment is changed from quarterly payment to half-yearly payment, then insurance may be optional. For example, contractor AB Flooring has changed the plan of credit offer payment from quarterly to half-yearly, therefore insurance to Alex is optional. In yet another case if the request for credit offer payment is changed from quarterly payment to annual payment, then insurance may be required. For example, contractor AB Flooring has changed the plan of credit offer payment from quarterly to annually, therefore insurance to Alex is required.

After determination of the need for insurance, the insurance module 110 may send a request to insurance network base module 120 to search for the insurance provider at step 606. In one embodiment, the insurance provider may be selected based on parameters including insurance amount required, type of insurance, and geolocation of the insurance. For example, the insurance module 110 requests the insurance network base module 120 for determining the insurance provider for Alex. In one embodiment, the insurance network base module 120 may access the insurance database 122 and the insurance provider database 124 for determine information related to the insurance provider for the contractor device 102.

The insurance module 110 may receive the insurance provider from the insurance network base module 120 at step 608. For example, for Alex, the insurance provider is Bank of America, with a term insurance for $5 million.

Further, after receiving the insurance provider, the insurance module 110 may send the searched insurance provider to the credit offer network base module 108 at step 610. For example, the insurance module 110 sends the details that Bank of America is the insurance provider for Alex, with a term insurance for $5 million.

The credit offer network base module 108 may monitor the insurance module 110 for the information related to the insurance provider at step 508. It can be noted that the insurance module 110 may continuously provide information related to the insurance provider. In one embodiment, the credit offer network base module 108 may monitor the insurance module 110 in real-time. Further, the credit offer network base module 108 receives information from the insurance module 110 at step 510. In one embodiment the information received may include at least but not limited to the need for insurance and insurance provider. For example, the credit offer network base module 108 receives information that the Bank of America is the insurance provider for Alex, with a term insurance for $5 million. In one embodiment, the credit offer network base module 108 may determine risks associated with the credit offer based on the insurance available for the contractor device 102. Further, if no insurance is found or low insurance value is determined, the credit offer network base module 108 may add risk to the credit offer or may add information of a potential risk to the credit offer. Further, based on the received information, the credit offer network base module 108 may determine if an insurance connection is required at step 512.

In an exemplary embodiment, the credit offer network base module 108 determines from the information received for contractor AB Flooring that the connection of the first contractor AB Flooring with a car insurance provider is required. Further, the credit offer network base module 108 may connect the received of the contractor devices 102 with the insurance provider at step 514. For example, the credit offer network base module 108 connects Alex with the Bank of America based on the information regarding the insurance is required, from the insurance module 110. In another case, when the insurance connection is not required, as insurance is not needed for the one of the one or more contractors then the credit offer network base module 108 may take the next contractor from the one or more contractor devices 102 and filter the current data for the selected next contractor from the one or more contractor devices 102 at step 504 at step 516. For example, the credit offer network base module 108 makes the determination from the information received from the insurance module 110 that insurance is not required to the first contractor AB Flooring, then the credit offer network base module 108 does not connect Alex with the Bank of America and takes Barrie Drywall to perform again filtration of the current data at step 504.

The subject disclosure describes a method for providing contractor information to adjust coverage. It can be noted that the method according to one embodiment may execute the method and algorithms for implementing an adjustment of the coverage which can include one or more local or remote executable software platforms, mobile device platforms, or a hosted Internet or network program or portal. In one embodiment, only portions of the system are computer operated, and in other embodiments, the entire system is computer operated. In one embodiment, client users may run an application on their mobile devices so that the network environment 100 can be easily accessed in real-time at a construction site. The system and method for providing contractor information for implementing coverage adjustment are fully integrated for use with any additional platform and data output that may be used for communicating with other platforms, such as for example financial institution platforms, user information platforms, cyber security platforms, and payment collection platforms.

While this invention has been disclosed with reference to specific embodiments, it is apparent that other embodiments and variations of this invention may be devised by others skilled in the art without departing from the true spirit and scope of the invention. It will be appreciated by those skilled in the art that changes could be made to the exemplary embodiments described above without departing from the broad inventive concept thereof. Therefore, it is to be understood that this disclosure is not limited to the particular embodiments disclosed, but it is intended to cover modifications within the spirit and scope of the subject disclosure as disclosed above.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims.

What is claimed is:

1. A method for automated data filtration and population for streamlined online processing, the method comprising:
receiving information over a communication network from a contractor database, the received information regarding a contractor;
applying a set of one or more data filters to the received information to create a filtered set of information;
generating at least one recommendation based on the filtered set of information, the at least one recommendation associated with an identified matching service provider and information regarding a connection to a system of the matching identified matching service provider;
establishing a connection between a device associated with the contractor and the system of the identified matching service provider; and
automatically implementing a workflow associated with the identified matching service provider based on the filtered set of information in accordance with the at least one recommendation.

2. The method of claim 1, wherein the matching service provider is identified from a plurality of different service providers, and further comprising identifying the workflow based on the identified matching service provider.

3. The method of claim 1, wherein the applied sets of filters are associated with the contractor, and wherein a different contractor is associated with a different set of one or more data filters.

4. The method of claim 1, further comprising storing historical data regarding one or more transactions in memory, wherein each transaction is associated with information regarding an indication of success or lack of success.

5. The method of claim 4, wherein generating the at least one recommendation is further based on the stored historical data.

6. The method of claim 4, wherein generating the at least one recommendation is further based on a learning model that includes the stored historical data.

7. The method of claim 1, wherein generating at least one recommendation includes automatically populating one or more online forms associated with one or more available service providers based on the filtered set of information, and wherein the at least one recommendation is based on results of the online forms.

8. The method of claim 1, wherein automatically implementing the workflow associated with the identified matching service includes automatically populating one or more online forms associated with the identified matching service provider.

9. The method of claim 1, further comprising generating a presentation of at least one recommendation, the presentation including a link associated with the system of the identified matching service provider, wherein the link is activated by the contractor device, and wherein establishing the connection between the contractor device and the system of the identified matching service provider is based on activation of a link associated with the at least one presented recommendation.

10. A system for automated data filtration and population for streamlined online processing, the system comprising:
a communication interface that communicates over a communication network to receive information from a contractor database, the received information regarding a contractor;
memory that stores a set of one or more data filters associated with the contractor; and
a processor that executes instructions stored in memory, wherein the processor executes the instructions to:
apply a set of one or more data filters to the received information to create a filtered set of information;
generate at least one recommendation based on the filtered set of information, the at least one recommendation associated with an identified matching service provider and information regarding a connection to a system of the matching identified matching service provider;
establish a connection between a device associated with the contractor and the system of the identified matching service provider; and
automatically implement a workflow associated with the identified matching service provider based on the filtered set of information in accordance with the at least one recommendation.

11. The system of claim 10, wherein the matching service provider is identified from a plurality of different service providers, and wherein the processor executes further instructions to identify the workflow based on the identified matching service provider.

12. The system of claim 10, wherein the applied sets of filters are associated with the contractor, and wherein a different contractor is associated with a different set of one or more data filters.

13. The system of claim 10, wherein memory further stores historical data regarding one or more transactions in memory, and wherein each transaction is associated with information regarding an indication of success or lack of success.

14. The system of claim 13, wherein the processor generates the at least one recommendation further based on the stored historical data.

15. The system of claim 13, wherein the processor generates the at least one recommendation further based on a learning model that includes the stored historical data.

16. The system of claim 10, wherein the processor generates the at least one recommendation by automatically populating one or more online forms associated with one or more available service providers based on the filtered set of information, and wherein the at least one recommendation is based on results of the online forms.

17. The system of claim 10, wherein the processor automatically implements the workflow associated with the identified matching service by automatically populating one or more online forms associated with the identified matching service provider.

18. The system of claim 10, wherein the processor executes further instructions to generate a presentation of at least one recommendation, the presentation including a link associated with the system of the identified matching service provider, wherien the link is activated by the contractor device, and wherein establishing the connection between the contractor device and the system of the identified matching service provider is based on activation of a link associated with the at least one presented recommendation.

19. A non-transitory, computer-readable storage medium, having embodied thereon a program executable by a processor to perform a method for automated data filtration and population for streamlined online processing, the method comprising:
receiving information over a communication network from a contractor database, the received information regarding a contractor;
applying a set of one or more data filters to the received information to create a filtered set of information;
generating at least one recommendation based on the filtered set of information, the at least one recommendation associated with an identified matching service provider and information regarding a connection to a system of the matching identified matching service provider;
establishing a connection between a device associated with the contractor and the system of the identified matching service provider; and
automatically implementing a workflow associated with the identified matching service provider based on the filtered set of information in accordance with the at least one recommendation.
